(19) United States
(12) Patent Application Publication
(10) Pub. No.: US 2015/0296073 A1
(43) Pub. Date: Oct. 15, 2015

(54) BLUETOOTH REMOTE CONTROL SYSTEM AND RELATED DEVICE

(71) Applicant: Realtek Semiconductor Corp., Hsinchu (TW)

(72) Inventors: Chen-Hsing LO, Taoyuan City (TW); Yu-Hsuan LIU, Taipei City (TW); Chia-Chun HUNG, Hsinchu City (TW); Wei-Feng MAO, Jiangsu (CN); Shi-Meng ZOU, Jiangsu (CN); Chin-Chiu LI, Tainan City (TW); Yong LIU, Jiangsu (CN); Chun-Xia GUO, Jiangsu (CN)

(73) Assignee: REALTEK SEMICONDUCTOR CORP., Hsinchu (TW)

(21) Appl. No.: 14/684,941

(22) Filed: Apr. 13, 2015

(30) Foreign Application Priority Data
Apr. 15, 2014 (CN) 201410151253.9

(51) Int. Cl. H04M 1/725; H04W 52/02; H04W 8/00; H04W 4/00

(52) U.S. Cl. CPC H04M 1/72533; H04W 4/008; H04W 52/0235; H04W 8/005

(57) ABSTRACT

A Bluetooth remote control system and related transmitting-end Bluetooth device and receiving-end Bluetooth device are disclosed. The transmitting-end Bluetooth device includes: a Bluetooth transmitting circuit; a receiving interface configured to operably receive a user trigger signal; a packet generating circuit configured to operably insert a power on request into one or more predetermined advertising packets to form one or more target advertising packets; and a Bluetooth control circuit configured to operably control the Bluetooth transmitting circuit to transmit the one or more target advertising packets. Each of the predetermined advertising packets is an advertising indication (ADV_IND) packet, a non-connectable advertising indication (ADV_NONCONN_IND) packet, or a discoverable advertisement indication (ADV_DISCOVER_IND) packet.

### CROSS-REFERENCE TO RELATED APPLICATIONS

This application claims the benefit of priority to Patent Application No. 201410151253.9, filed in China on Apr. 15, 2014; the entirety of which is incorporated herein by reference for all purposes.

### BACKGROUND

The disclosure generally relates to Bluetooth apparatuses and, more particularly, to a Bluetooth remote control system and related devices.

Some electronic devices are provided with an infrared receiving circuit and a Bluetooth protocol stack layer circuit, and thus they are capable of pairing with other Bluetooth device to establish a Bluetooth bond under normal operations after powered on. Once the electronic device is powered off, the Bluetooth protocol stack layer circuit inside the electronic device is also turned off to reduce power consumption. In this situation, the user is only allowed to utilize a conventional infrared remote control to instruct a target device to conduct a power on procedure, but not allowed to remotely control the target device to conduct the power on procedure through other Bluetooth devices.

As is well known in the art, the infrared remote control transmits control commands through directional infrared signals. Therefore, when the user wants to remotely control the target device, the user is required to point the signal transmission terminal of the remote control toward the infrared receiving terminal of the target device. In addition, the distance between the target device and the remote control is also restricted in a certain short range, or the infrared receiving circuit of the target device may not be able to receive the infrared signals generated by the remote control. Apparently, the aforementioned remote control approach severely restricts the user's operating behavior and causes considerable inconvenience to many people.

### SUMMARY

In view of the foregoing, it may be appreciated that a substantial need exists for methods and apparatuses that mitigate or reduce the problems above.

An example embodiment of a Bluetooth remote control system is disclosed, comprising: a first component, a transmitting-end Bluetooth device, and a target device. The transmitting-end Bluetooth device comprises: a Bluetooth transmitting circuit; a receiving interface, configured to operably receive a user trigger signal generated by a trigger device of the Bluetooth remote control system; a packet generating circuit, coupled with the receiving interface, configured to operably insert a power-on request into one or more predetermined advertising packets to form one or more target advertising packets when the user trigger signal is received by the receiving interface; and a Bluetooth control circuit, coupled with the Bluetooth transmitting circuit and the packet generating circuit, configured to operably control the Bluetooth transmitting circuit to transmit the one or more target advertising packets. The target device comprises: a power-on signal generating circuit; a control circuit; a Bluetooth protocol stack layer circuit; and a receiving-end Bluetooth device. The receiving-end Bluetooth device comprises: a Bluetooth receiving circuit, configured to operably receive the one or more target advertising packets; a packet parsing circuit, coupled with the Bluetooth receiving circuit, configured to operably parse the one or more target advertising packets so as to extract the power-on request when the Bluetooth protocol stack layer circuit is turned off; a wake-up signal generating circuit, coupled with the packet parsing circuit, configured to operably generate a wake-up signal according to the power-on request; and a wake-up interface, coupled with the wake-up signal generating circuit and the power-on signal generating circuit, configured to operably transmit the wake-up signal to the power-on signal generating circuit so as to instruct the power-on signal generating circuit to generate and transmit a power-on signal to the control circuit. Each of the one or more predetermined advertising packets is an advertising indication packet, a non-connectable advertising indication packet, or a discoverable advertisement indication packet.

Another example embodiment of a transmitting-end Bluetooth device for use in a Bluetooth remote control system is disclosed. The transmitting-end Bluetooth device comprises: a Bluetooth transmitting circuit; a receiving interface, configured to operably receive a user trigger signal generated by a trigger device of the Bluetooth remote control system; a packet generating circuit, coupled with the receiving interface, configured to operably insert a power-on request into one or more predetermined advertising packets to form one or more target advertising packets when the user trigger signal is received by the receiving interface; and a Bluetooth control circuit, coupled with the Bluetooth transmitting circuit and the packet generating circuit, configured to operably control the Bluetooth transmitting circuit to transmit the one or more target advertising packets. Each of the one or more predetermined advertising packets is an advertising indication packet, a non-connectable advertising indication packet, or a discoverable advertisement indication packet.

Another example embodiment of a receiving-end Bluetooth device for use in a Bluetooth remote control system is disclosed. The Bluetooth remote control system comprises a transmitting-end Bluetooth device and a target device. The target device comprises a power-on signal generating circuit, a control circuit, a Bluetooth protocol stack layer circuit, and the receiving-end Bluetooth device. The control circuit is coupled with the power-on signal generating circuit and the Bluetooth protocol stack layer circuit. The receiving-end Bluetooth device comprises: a Bluetooth receiving circuit, configured to operably receive the one or more target advertising packets; a packet parsing circuit, coupled with the Bluetooth receiving circuit, configured to operably parse the one or more target advertising packets so as to extract the power-on request when the Bluetooth protocol stack layer circuit is turned off; a wake-up signal generating circuit, coupled with the packet parsing circuit, configured to operably generate a wake-up signal according to the power-on request; and a wake-up interface, coupled with the wake-up signal generating circuit, utilized for coupling with the power-on signal generating circuit, and configured to operably transmit the wake-up signal to the power-on signal generating circuit so as to instruct the power-on signal generating circuit to generate and transmit a power-on signal to the control circuit. Each of the one or more predetermined advertising packets is an advertising indication packet, a non-connectable advertising indication packet, or a discoverable advertisement indication packet.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a Bluetooth remote control system according to one embodiment of the present disclosure.

FIG. 2 shows a simplified flowchart of a method for remotely controlling a target device to conduct a power on procedure through Bluetooth signals according to one embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

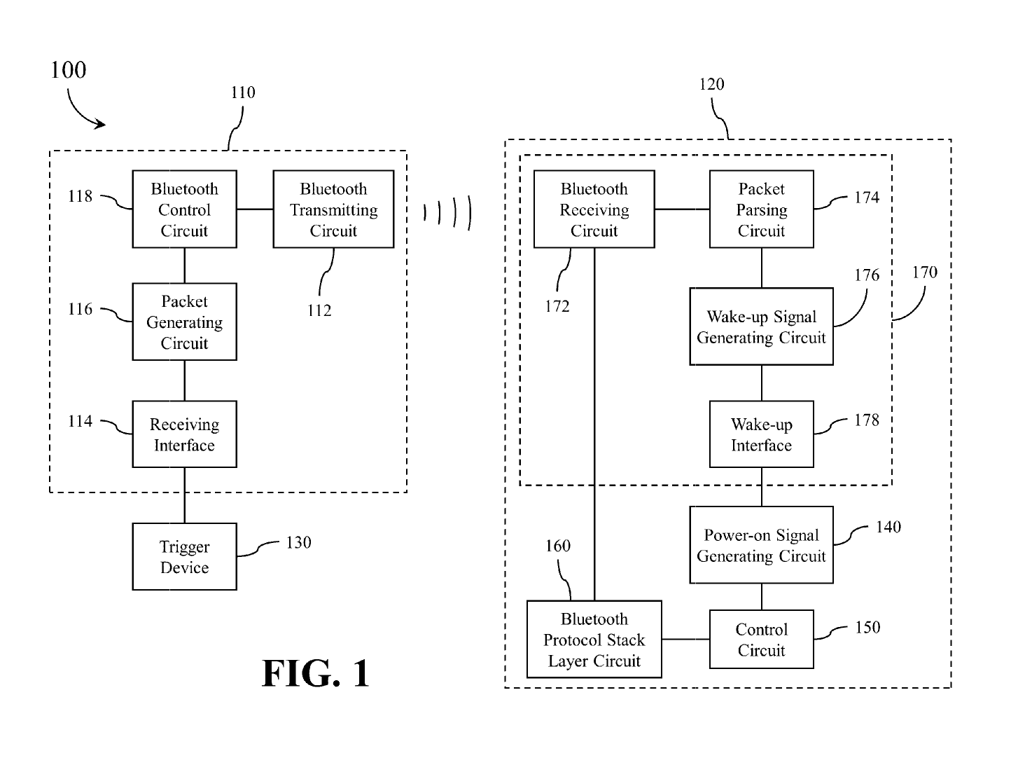

FIG. 1 shows a simplified functional block diagram of a Bluetooth remote control system 100 according to one embodiment of the present disclosure. The Bluetooth remote control system 100 comprises a transmitting-end Bluetooth device 110, one or more target devices to be controlled (e.g., an example target device 120 is shown in FIG. 1), and a trigger device 130. The transmitting-end Bluetooth device 110 may be a stand-alone device, or may be partial circuit integrated in other device (e.g., a remote control).

In the embodiment of FIG. 1, the transmitting-end Bluetooth device 110 comprises a Bluetooth transmitting circuit 112, a receiving interface 114, a packet generating circuit 116, and a Bluetooth control circuit 118. The target device 120 comprises a power-on signal generating circuit 140, a control circuit 150, a Bluetooth protocol stack layer circuit 160, and a receiving-end Bluetooth device 170. The receiving-end Bluetooth device 170 comprises a Bluetooth receiving circuit 172, a packet parsing circuit 174, a wake-up signal generating circuit 176, and a wake-up interface 178.

In the transmitting-end Bluetooth device 110, the receiving interface 114 is configured to operably receive a user trigger signal generated by the trigger device 130. The packet generating circuit 116 is coupled with the receiving interface 114 and configured to operably insert a power-on request and a target device identification data into one or more predetermined advertising packets to form one or more target advertising packets when the user trigger signal is received by the receiving interface 114. The Bluetooth control circuit 118 is coupled with the Bluetooth transmitting circuit 112 and the packet generating circuit 116. The Bluetooth control circuit 118 is configured to operably control the Bluetooth transmitting circuit 112 to transmit the one or more target advertising packets.

In practice, different functional blocks of the transmitting-end Bluetooth device 110 may be realized with separate circuits, or may be integrated into a single circuit chip. In addition, the Bluetooth transmitting circuit 112 may be coupled with external antenna apparatuses (not shown) if needed.

The aforementioned trigger device 130 may be realized with various apparatuses configured to be able to generate corresponding user trigger signal in response to the user's simple manipulation, such as a button, a switch, a touch screen, a keyboard, a computer mouse, a voice-activated device, a gesture sensing device, a gyroscope, a circuitry adopting other signal triggering technology, or a combination of above devices. In practice, the trigger device 130 may be installed outside the transmitting-end Bluetooth device 110, or may be integrated into the transmitting-end Bluetooth device 110.

In the target device 120, the control circuit 150 is coupled with the power-on signal generating circuit 140 and the Bluetooth protocol stack layer circuit 160. The receiving-end Bluetooth device 170 is coupled with the power-on signal generating circuit 140 and the Bluetooth protocol stack layer circuit 160.

In the receiving-end Bluetooth device 170, the Bluetooth receiving circuit 172 is configured to receive packets transmitted from other Bluetooth devices. The packet parsing circuit 174 is coupled with the Bluetooth receiving circuit 172 and configured to operably parse the packets received by the Bluetooth receiving circuit 172 when the Bluetooth protocol stack layer circuit 160 is turned off. For example, when the Bluetooth protocol stack layer circuit 160 is turned off (i.e., when the target device 120 is turned off), if the Bluetooth receiving circuit 172 receives the one or more target advertising packets transmitted from the Bluetooth transmitting circuit 112, the packet parsing circuit 174 parses the one or more target advertising packets to extract the aforementioned power-on request and the target device identification data. The wake-up signal generating circuit 176 is coupled with the packet parsing circuit 174 and configured to operably generate a wake-up signal according to the power-on request. The wake-up interface 178 is coupled with the wake-up signal generating circuit 176 and configured to operably transmit the wake-up signal to the power-on signal generating circuit 140 so as to instruct the power-on signal generating circuit 140 to generate and transmit a power-on signal to the control circuit 150 to instruct the control circuit 150 to conduct a power on procedure.

In practice, different functional blocks of the target device 120 may be realized with separate circuits, or may be integrated into a single circuit chip. In addition, the Bluetooth receiving circuit 172 may be coupled with external antenna apparatuses (not shown) if needed. In practical applications, the target device 120 may be any electronic device that could be controlled by a remote control. For example, the target device 120 may be a television, an audio device, a DVD player, a home theater system, a smart home appliance, or the like.

The term “predetermined advertising packet” as used throughout the description and the claims refers to an advertising indication (ADV_IND) packet, a non-connectable advertising indication (ADV_NONCONN_IND) packet, or a discoverable advertisement indication (ADV_DISCOVER_IND) packet. Similarly, the aforementioned term “target advertising packet” also refers to an advertising indication (ADV_IND) packet, a non-connectable advertising indication (ADV_NONCONN_IND) packet, or a discoverable advertisement indication (ADV_DISCOVER_IND) packet. The term “power-on request” as used throughout the description and the claims refers to any indication information or command for requesting the target device to conduct a power on procedure.

When the target device 120 operates under normal situation after powering on, the Bluetooth protocol stack layer circuit 160 in the target device 120 may conduct pairing with other Bluetooth devices to establish Bluetooth bonds through the Bluetooth receiving circuit 172 or other Bluetooth communication circuit (not shown). In order to reduce power consumption, when the target device 120 is turned off, both the control circuit 150 and the Bluetooth protocol stack layer circuit 160 inside the target device 120 would be turned off, while only a tiny portion of electricity is supplied to the power-on signal generating circuit 140 and the receiving-end Bluetooth device 170.

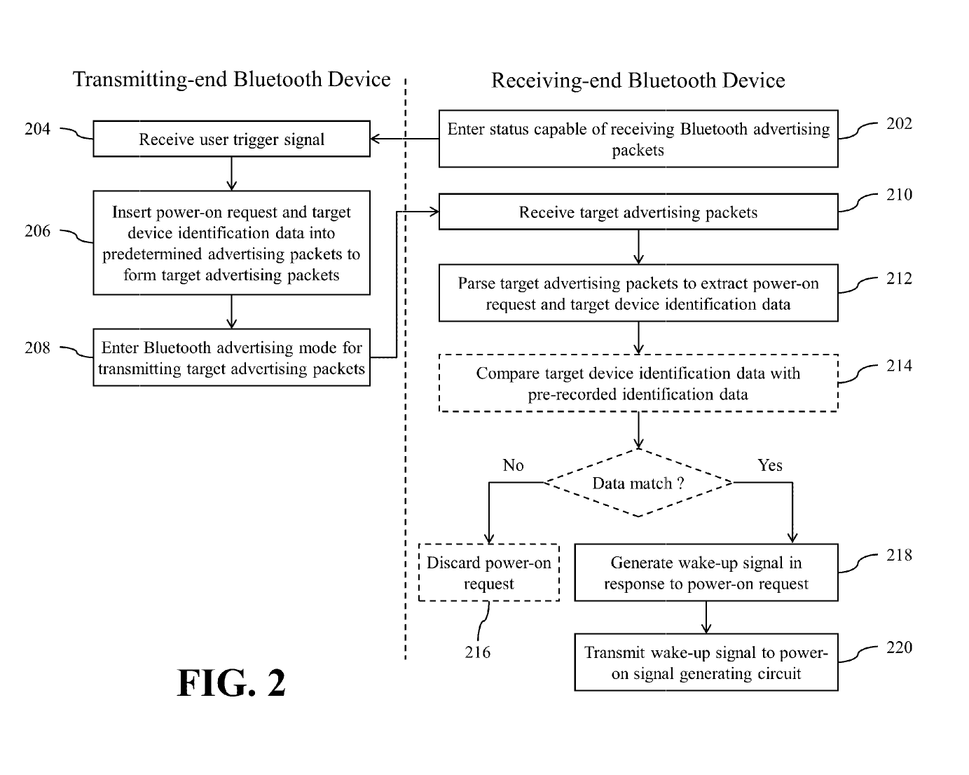

The operations of the Bluetooth remote control system 100 will be further described in the following by reference to FIG. 2.

FIG. 2 shows a simplified flowchart of a method for remotely controlling the target device 120 to conduct a power on procedure through Bluetooth signals according to one embodiment of the present disclosure. In the flowchart of FIG. 2, operations within a column under the name of a specific device are operations to be performed by the specific device. For example, operations within a column under the label “Transmitting-end Bluetooth Device” are operations to be performed by the transmitting-end Bluetooth device 110, operations within a column under the label “Receiving-end Bluetooth Device” are operations to be performed by the receiving-end Bluetooth device 170.

As described previously, when the target device 120 is turned off, both the control circuit 150 and the Bluetooth protocol stack layer circuit 160 inside the target device 120 are turned off to reduce power consumption.

In this situation, the Bluetooth receiving circuit 172 performs the operation 202 to enter a status capable of receiving Bluetooth advertising packets.

Afterward, when the user wants to instruct the target device 120 to conduct a power on procedure through the transmitting-end Bluetooth device 110, the user may conduct predetermined manipulation to the trigger device 130 so as to instruct the trigger device 130 to generate a corresponding user trigger signal. At this time, the receiving interface 114 performs the operation 204 to receive the user trigger signal generated by the trigger device 130 and to notify the packet generating circuit 116 regarding the same.

When the user trigger signal transmitted from the trigger device 130 is received by the receiving interface 114, the packet generating circuit 116 performs the operation 206.

In the operation 206, the packet generating circuit 116 inserts the aforementioned power-on request and a target device identification data corresponding to the target device 120 into one or more predetermined advertising packets to form one or more target advertising packets. In practice, the packet generating circuit 116 may insert the power-on request and the target device identification data into the advertisement data (AdvData) fields in the payload of the one or more predetermined advertising packets to form the one or more target advertising packets. For example, the packet generating circuit 116 may define the data type of one or more extended inquiry response (EIR) data structures in the advertisement data fields to be vendor specific messages, and inserts the power-on request and the target device identification data into the one or more EIR data structures.

In the operation 208, the Bluetooth control circuit 118 controls the Bluetooth transmitting circuit 112 to enter a Bluetooth advertising mode for transmitting the one or more target advertising packets. For example, when the transmitting-end Bluetooth device 110 supports the Bluetooth low energy (BLE) standard, the Bluetooth control circuit 118 in the operation 208 may control the Bluetooth transmitting circuit 112 to enter a BLE advertising mode to transmit the one or more target advertising packets.

In the operation 210, the Bluetooth receiving circuit 172 receives the one or more target advertising packets transmitted from the Bluetooth transmitting circuit 112.

At this time, the Bluetooth protocol stack layer circuit 160 stays in the turn-off status, but the packet parsing circuit 174 performs the operation 212 to parse the one or more target advertising packets received by the Bluetooth receiving circuit 172 so as to extract the aforementioned power-on request and target device identification data. For example, in the embodiment where the packet generating circuit 116 inserts the power-on request and the target device identification data into the EIR data structures of the target advertising packets, the packet parsing circuit 174 may extract the power-on request and the target device identification data from corresponding positions within the advertisement data fields in the payload of the one or more target advertising packets.

In the operation 214, the packet parsing circuit 174 compares the target device identification data with a pre-recorded identification data. If the target device identification data does not match with the pre-recorded identification data, the packet parsing circuit 174 determines that the power-on request is not targeted to the target device 120, and thus proceeds to the operation 216. On the contrary, if the target device identification data matches with the pre-recorded identification data, then the packet parsing circuit 174 performs the operation 218.

In other words, the packet parsing circuit 174 does not require the Bluetooth protocol stack layer circuit 160 to intervene in the aforementioned operations 212 and 214.

In the operation 216, the packet parsing circuit 174 discards the power-on request.

In the operation 218, the packet parsing circuit 174 transmits the power-on request to the wake-up signal generating circuit 176, so that the wake-up signal generating circuit 176 generate the wake-up signal in response to the power-on request.

In other words, the wake-up signal generating circuit 176 generate the wake-up signal according to the power-on request only if the target device identification data matches with the pre-recorded identification data.

Then, the wake-up signal generating circuit 176 performs the operation 220 to transmit the wake-up signal to the power-on signal generating circuit 140 through the wake-up interface 178 so as to instruct the power-on signal generating circuit 140 to generate and transmit a power-on signal to the control circuit 150.

When the power-on signal is received by the control circuit 150, a power on procedure is initiated to resume power supply to other major circuits including the Bluetooth protocol stack layer circuit 160 so as to render the target device 120 to enter a normal operation status.

It can be appreciated from the foregoing descriptions that when the receiving-end Bluetooth device 170 operates in the status capable of receiving Bluetooth advertising packets, the user only needs to conduct a simple manipulation to the trigger device 130 coupled with the transmitting-end Bluetooth device 110, such as pressing a button, activating a switch, or the like. Then the transmitting-end Bluetooth device 110 would cooperate with the receiving-end Bluetooth device 170 to instruct the power-on signal generating circuit 140 to initiate the power on procedure of the target device 120. In the entire process that the transmitting-end Bluetooth device 110 remotely controls the target device 120 to conduct the power on procedure, the Bluetooth protocol stack layer circuit 160 is not required to perform any operation at all. Therefore, even if the Bluetooth protocol stack layer circuit 160 is turned off, the control circuit 150 is still enabled to conduct the power on procedure according to the instruction of the power-on signal generating circuit 140.

In addition, since the wake-up signal generating circuit 176 generates the wake-up signal according to the power-on request only if the packet parsing circuit 174 determines that the received target device identification data matches with the pre-recorded identification data. Accordingly, in the embodiment where multiple target devices present in the Bluetooth remote control system 100, since the target advertising packet generated by the transmitting-end Bluetooth device 110 contains the power-on request and a target device identification data, only a single target device matching with the pre-recorded identification data would conduct the power on procedure in response to the target advertising packet. Meanwhile, other target devices would maintain in the power-off status and do not react erroneously.

Since the Bluetooth signals are not directional signals, the aforementioned Bluetooth remote control system 100 does not demand the related position between the transmitting-end Bluetooth device 110 and the receiving-end Bluetooth device 170 to meet any special pattern. Therefore, it greatly improves the convenience for the user to remotely control the target device.

Another advantage of the Bluetooth remote control system 100 is that the receiving-end Bluetooth device 170 may replace the functionality of the infrared receiving circuit (not shown) of the target device 120. Accordingly, the transmitting-end Bluetooth device 110 may be utilized as the remote control of the target device 120 to replace the outdated infrared remote control.

In the previous embodiments, the packet generating circuit 116 inserts a target device identification data corresponding to the target device 120 into the one or more predetermined advertising packets to form the one or more target advertising packets. But this is merely an example embodiment, rather than a restriction to practical implementations.

For example, in some embodiments where only a single target device (such as the aforementioned target device 120) is present in the Bluetooth remote control system 100, the packet generating circuit 116 may only insert the power-on request into the one or more predetermined advertising packets to form the one or more target advertising packets in the operation 206. Under this situation, the packet parsing circuit 174 may only extract the power-on request from the one or more target advertising packets in the operation 212. Accordingly, the packet parsing circuit 174 may skip the operation 214 and proceed directly to the operation 218.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A Bluetooth remote control system, comprising:
a transmitting-end Bluetooth device, comprising:
a Bluetooth transmitting circuit;
a receiving interface, configured to operably receive a user trigger signal generated by a trigger device of the Bluetooth remote control system;
a packet generating circuit, coupled with the receiving interface, configured to operably insert a power-on request into one or more predetermined advertising packets to form one or more target advertising packets when the user trigger signal is received by the receiving interface; and
a Bluetooth control circuit, coupled with the Bluetooth transmitting circuit and the packet generating circuit, configured to operably control the Bluetooth transmitting circuit to transmit the one or more target advertising packets; and
a target device, comprising:
a power-on signal generating circuit;
a control circuit;
a Bluetooth protocol stack layer circuit; and
a receiving-end Bluetooth device, comprising:
a Bluetooth receiving circuit, configured to operably receive the one or more target advertising packets;
a packet parsing circuit, coupled with the Bluetooth receiving circuit, configured to operably parse the one or more target advertising packets so as to extract the power-on request when the Bluetooth protocol stack layer circuit is turned off;
a wake-up signal generating circuit, coupled with the packet parsing circuit, configured to operably generate a wake-up signal according to the power-on request; and
a wake-up interface, coupled with the wake-up signal generating circuit and the power-on signal generating circuit, configured to operably transmit the wake-up signal to the power-on signal generating circuit so as to instruct the power-on signal generating circuit to generate and transmit a power-on signal to the control circuit;
wherein each of the one or more predetermined advertising packets is an advertising indication packet, a non-connectable advertising indication packet, or a discoverable advertisement indication packet.

2. The Bluetooth remote control system of claim 1, wherein the Bluetooth control circuit controls the Bluetooth transmitting circuit to enter a Bluetooth advertising mode so as to transmit the one or more target advertising packets.

3. The Bluetooth remote control system of claim 1, wherein the packet generating circuit inserts the power-on request and a target device identification data into the one or more predetermined advertising packets to form the one or more target advertising packets, and the packet parsing circuit parses the one or more target advertising packets to extract the power-on request and the target device identification data.

4. The Bluetooth remote control system of claim 3, wherein the wake-up signal generating circuit is further configured to operably compare the target device identification data with a pre-recorded identification data, and the wake-up signal generating circuit generates the wake-up signal according to the power-on request only if the target device identification data matches with the pre-recorded identification data.

5. A transmitting-end Bluetooth device for use in a Bluetooth remote control system, the transmitting-end Bluetooth device comprising:
a Bluetooth transmitting circuit;
a receiving interface, configured to operably receive a user trigger signal generated by a trigger device of the Bluetooth remote control system;
a packet generating circuit, coupled with the receiving interface, configured to operably insert a power-on request into one or more predetermined advertising packets to form one or more target advertising packets when the user trigger signal is received by the receiving interface; and
a Bluetooth control circuit, coupled with the Bluetooth transmitting circuit and the packet generating circuit, configured to operably control the Bluetooth transmitting circuit to transmit the one or more target advertising packets;
wherein each of the one or more predetermined advertising packets is an advertising indication packet, a non-connectable advertising indication packet, or a discoverable advertisement indication packet.

6. The transmitting-end Bluetooth device of claim 5, wherein the Bluetooth control circuit controls the Bluetooth transmitting circuit to enter a Bluetooth advertising mode so as to transmit the one or more target advertising packets.

7. The transmitting-end Bluetooth device of claim 5, wherein the packet generating circuit inserts the power-on request and a target device identification data into the one or more predetermined advertising packets to form the one or more target advertising packets.

8. A receiving-end Bluetooth device for use in a Bluetooth remote control system, the Bluetooth remote control system comprising a transmitting-end Bluetooth device and a target device, the target device comprising a power-on signal generating circuit, a control circuit, a Bluetooth protocol stack layer circuit, and the receiving-end Bluetooth device, wherein the control circuit is coupled with the power-on signal generating circuit and the Bluetooth protocol stack layer circuit, the receiving-end Bluetooth device comprising:
a Bluetooth receiving circuit, configured to operably receive the one or more target advertising packets;
a packet parsing circuit, coupled with the Bluetooth receiving circuit, configured to operably parse the one or more target advertising packets so as to extract the power-on request when the Bluetooth protocol stack layer circuit is turned off;
a wake-up signal generating circuit, coupled with the packet parsing circuit, configured to operably generate a wake-up signal according to the power-on request; and
a wake-up interface, coupled with the wake-up signal generating circuit, utilized for coupling with the power-on signal generating circuit, and configured to operably transmit the wake-up signal to the power-on signal generating circuit so as to instruct the power-on signal generating circuit to generate and transmit a power-on signal to the control circuit;
wherein each of the one or more predetermined advertising packets is an advertising indication packet, a non-connectable advertising indication packet, or a discoverable advertisement indication packet.

9. The receiving-end Bluetooth device of claim 8, wherein the packet parsing circuit parses the one or more target advertising packets to extract the power-on request and a target device identification data.

10. The receiving-end Bluetooth device of claim 9, wherein the wake-up signal generating circuit is further configured to operably compare the target device identification data with a pre-recorded identification data, and the wake-up signal generating circuit generates the wake-up signal according to the power-on request only if the target device identification data matches with the pre-recorded identification data.
